(19) United States
(12) Patent Application Publication
(10) Pub. No.: US 2025/0182452 A1
(43) Pub. Date: Jun. 5, 2025

(54) POINT CLOUD IDENTIFYING DEVICE, LEARNING DEVICE, POINT CLOUD IDENTIFYING METHOD, AND LEARNING METHOD

(71) Applicant: Mitsubishi Electric Corporation, Tokyo (JP)

(72) Inventor: Ryoma Yataka, Tokyo (JP)

(73) Assignee: Mitsubishi Electric Corporation, Tokyo (JP)

(21) Appl. No.: 19/047,250

(22) Filed: Feb. 6, 2025

Related U.S. Application Data
(63) Continuation of application No. PCT/JP2022/040937, filed on Nov. 2, 2022.

(51) Int. Cl. G06V 10/764; G06V 10/776

(52) U.S. Cl. CPC G06V 10/764; G06V 10/776

(57) ABSTRACT

A point cloud identifying device includes a point cloud acquiring unit to acquire point cloud information indicating N (N≥2) points in k (k≥2) dimensions, a model acquiring unit to acquire a model having a learning parameter, a rotation invariant converting unit to perform orthogonalization of each of basis vectors for each of points indicated in the point cloud information, and calculate a rotation invariant feature by using data after the orthogonalization, an inference unit to identify a point cloud indicated in the point cloud information by using the rotation invariant feature and the model, and a result output unit to output a classification result by identification of the inference unit.

### CROSS REFERENCE TO RELATED APPLICATION

This application is a Continuation of PCT International Application No. PCT/JP2022/040937, filed on Nov. 2, 2022, which is hereby expressly incorporated by reference into the present application.

### TECHNICAL FIELD

The present disclosure technology relates to a point cloud identification technology for identifying a point cloud indicated by point cloud information.

### BACKGROUND ART

For example, a detection result by a sensor such as LiDAR or radar may be indicated in the form of point cloud information including a large number of points. There is a technique for extracting a feature of a point cloud indicated by such point cloud information. Patent Literature 1 discloses a feature representing device that represents a feature of a point cloud. Specifically, a feature representing device of Patent Literature 1 is a feature representing device for feature representation of three-dimensional point cloud data (point cloud information), and includes a distance field converting unit that converts a set of points into a distance field indicating coordinates sₓ, s_{y}, and s_{z} of a spatial sample point s set around the points and a nearest neighbor distance φ(s) from the spatial sample point s to a nearest neighbor point, a regular projection unit that obtains a conversion into a standard coordinate system by performing singular value decomposition of a matrix M including the coordinates sₓ, s_{y}, and s_{z} of the spatial sample point s and the nearest neighbor distance φ(s), and a parameterization unit that outputs a weight β as a feature vector of the three-dimensional point cloud data by training an expression learning machine that receives, as input, a coordinate Lᵢₙ of the spatial sample point s converted into the standard coordinate system and outputs the nearest neighbor distance φ(s).

The feature representing device of Patent Literature 1 is configured to align, for example, a point cloud and a point cloud obtained by rotating the point cloud using a nearest neighbor distance to a spatial sample point set around the point cloud.

### CITATION LIST

### Patent Literatures

Patent Literature 1: JP 2019-133545 A

### SUMMARY OF INVENTION

### Technical Problem

However, the feature representing device of Patent Literature 1 has a problem that, depending on the point cloud, an error occurs at the time of positioning using the nearest neighbor distance between the point cloud and the spatial sample point, and a point cloud having the same shape may be identified as a point cloud having a different shape, and accuracy of identifying the point cloud tends to be low.

The present disclosure solves the above problem, and an object thereof is to improve accuracy of identifying a point cloud.

### Solutions to Problem

A point cloud identifying device of the present disclosure includes: processing circuitry configured to: acquire point cloud information indicating N (N≥2) points in k (k≥2) dimensions; acquire a model having a learning parameter; perform orthogonalization of each of basis vectors for each of points indicated in the point cloud information, and calculate a rotation invariant feature by using data after the orthogonalization; identify a point cloud indicated in the point cloud information by using the rotation invariant feature and the model; and output a classification result having been identified.

### Advantageous Effects of Invention

According to the present disclosure, it is possible to improve accuracy of identifying a point cloud.

### BRIEF DESCRIPTION OF DRAWINGS

FIG. 1 is a diagram illustrating an example of a configuration of a point cloud identifying system including a point cloud identifying device according to a first embodiment.

FIG. 2 is a diagram illustrating an example of a configuration of a rotation invariant converting unit in the point cloud identifying device.

FIG. 3 is a flowchart illustrating an example of processing of the point cloud identifying device.

FIG. 4 is a flowchart illustrating a specific example of rotation invariant converting processing in the processing of the point cloud identifying device.

FIG. 5 is a diagram describing rotation of a point cloud.

FIG. 6A is a diagram describing a relationship between rotation of point clouds indicating the same shapes and subspaces. FIG. 6B is a diagram describing a relationship between point clouds illustrating different shapes and subspaces.

FIG. 7 is a diagram illustrating an example of a configuration of a point cloud learning system 2 including a point cloud learning device according to a second embodiment.

FIG. 8 is a flowchart illustrating an example of processing of the point cloud learning device.

FIG. 9 is a diagram illustrating a first example of a hardware configuration for implementing functions of the point cloud identifying device or the point cloud learning device in the present disclosure.

FIG. 10 is a diagram illustrating a second example of a hardware configuration for implementing the functions of the point cloud identifying device or the point cloud learning device in the present disclosure.

### DESCRIPTION OF EMBODIMENTS

Hereinafter, in order to describe the present disclosure in more detail, embodiments of the present disclosure will be described with reference to the accompanying drawings.

### First Embodiment

In a first embodiment, a form of a point cloud identifying device will be described.

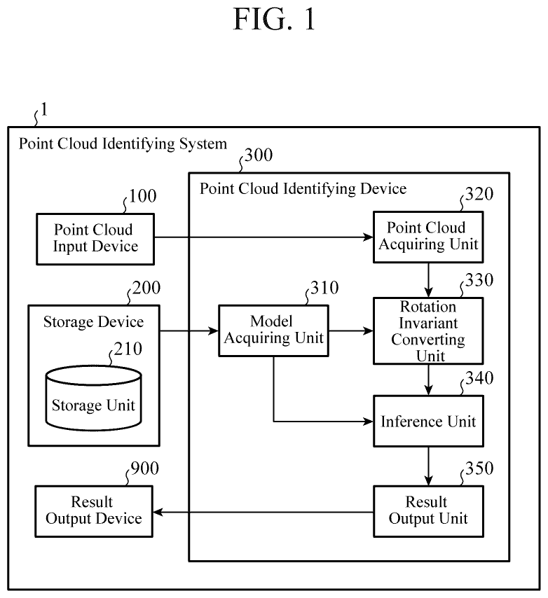

FIG. 1 is a diagram illustrating an example of a configuration of a point cloud identifying system 1 including a point cloud identifying device 300 according to the first embodiment.

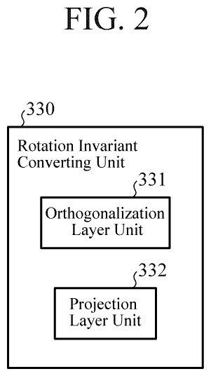

FIG. 2 is a diagram illustrating an example of a configuration of a rotation invariant converting unit 330 in the point cloud identifying device 300.

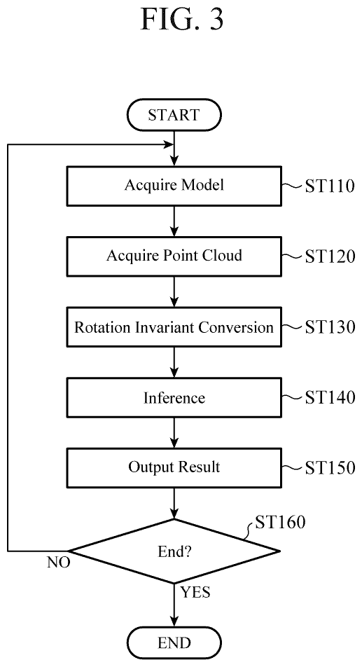

FIG. 3 is a flowchart illustrating an example of processing of the point cloud identifying device 300.

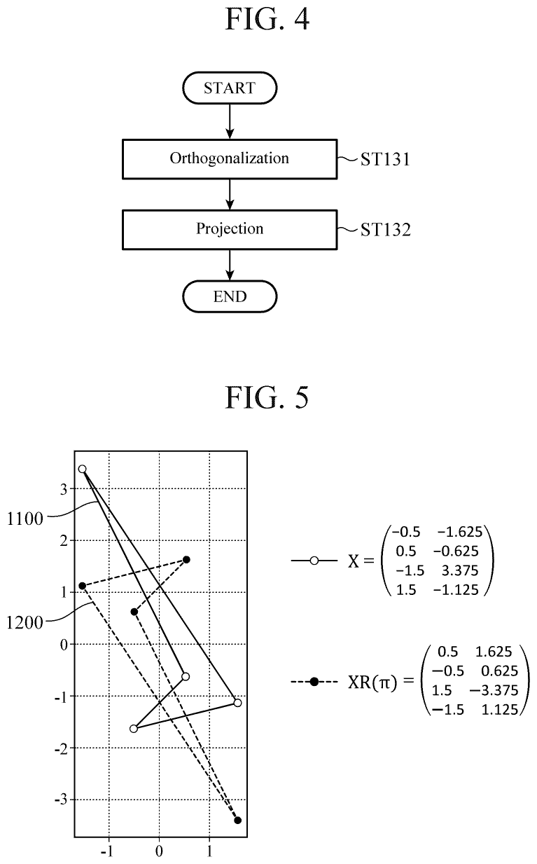

FIG. 4 is a flowchart illustrating a specific example of rotation invariant converting processing in the processing of the point cloud identifying device 300.

FIG. 5 is a diagram describing rotation of point clouds 1100 and 1200.

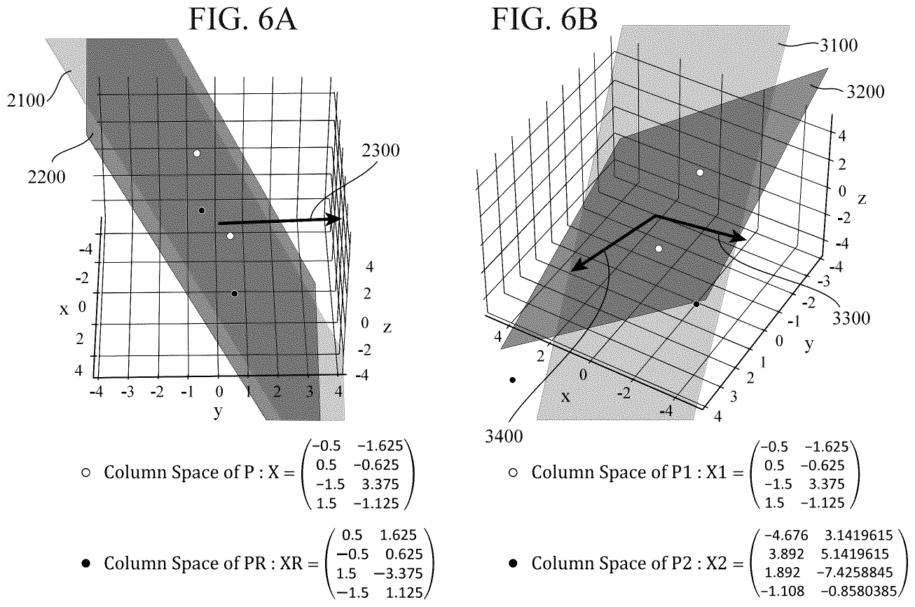

FIG. 6A is a diagram describing the relationship between rotation of point clouds indicating the same shape and subspaces 2100 and 2200. FIG. 6B is a diagram describing the relationship between point clouds indicating different shape and subspaces 3100 and 3200.

An example of a configuration of the point cloud identifying system 1 including the point cloud identifying device 300 will be described.

The point cloud identifying system 1 is a system including a point cloud identifying device 300 that identifies a point cloud.

The point cloud identifying system 1 illustrated in FIG. 1 includes a point cloud input device 100, a storage device 200, the point cloud identifying device 300, and a result output device 900.

The point cloud input device 100 takes in point cloud information (point cloud data) from a sensor that is not illustrated, for example, and outputs the point cloud information to the point cloud identifying device 300.

The sensor that is not illustrated is, for example, a light detection and ranging (LiDAR) or a radar.

The point cloud information indicates a plurality of (N≥2) points representing position coordinates or features detected by the sensor that is not illustrated.

The point cloud information represents each point included in the point cloud in the form of, for example, a coordinate value in a k (k≥2) dimension.

The storage device 200 includes a storage unit 210.

The storage unit 210 has information used for identification processing of identifying a point cloud. Specifically, the storage unit 210 has, for example, a learning parameter as a model for identification.

The point cloud identifying device 300 identifies the point cloud using a learned model in the k-dimensional point cloud identification. The learned model includes, for example, a model that is appropriately learned as in a second embodiment.

The k-dimensional point cloud identification is to perform class identification of point cloud data indicating a point cloud represented in k dimensions on the basis of a feature such as a shape of the point cloud.

A configuration example of the point cloud identifying device 300 will be described.

The point cloud identifying device 300 includes a model acquiring unit 310, a point cloud acquiring unit 320, a rotation invariant converting unit 330, an inference unit 340, and a result output unit 350.

The model acquiring unit 310 acquires a model having a learning parameter.

The learning parameter is a parameter learned by the learning device and is a parameter used when the point cloud is identified.

The point cloud acquiring unit 320 acquires k-dimensional point cloud information of N points.

Specifically, the point cloud acquiring unit 320 acquires point cloud information indicating N (N≥2) points in k (k≥2) dimensions.

The rotation invariant converting unit 330 performs orthogonalization of each of basis vectors for each of points indicated in the point cloud information, and calculates a rotation invariant feature by using data after the orthogonalization.

The rotation invariant feature is a feature unique to the shape of the point cloud that is not affected even if the point cloud is rotated.

The inference unit 340 uses the rotation invariant feature and the model to identify the point cloud indicated in the point cloud information.

Specifically, for example, the inference unit 340 calculates a point cloud feature indicating a feature of the point cloud using the rotation invariant feature and the model, and identifies the point cloud using the point cloud feature. The point cloud feature is a feature unique to each category of the point cloud and indicates a feature effective for classifying the point cloud into classes. The point cloud feature is a feature that can be identified as one category in a point cloud of a horse and one category in a point cloud of a bird, for example, when the point cloud feature is identified by an animal type.

In addition, the inference unit 340 may be configured to extract the shape of the point cloud and identify the point cloud by a method using a filter for extracting object-specific information from the shape of the point cloud. In this case, for example, when discriminating between a horse and a bird, a filter is designed so as to extract a head shape, the number of feet, the presence or absence of wings, the presence or absence of a beak, and the like as features, and the inference unit 340 extracts a point cloud feature using the filter, and discriminates a point cloud using the point cloud feature.

The result output unit 350 outputs a classification result by identification of the inference unit 340.

Specifically, the result output unit 350 outputs the classification result to the result output device 900.

An example of an internal configuration of the rotation invariant converting unit 330 will be described.

The rotation invariant converting unit 330 illustrated in FIG. 2 includes an orthogonalization layer unit 331 and a projection layer unit 332.

The orthogonalization layer unit 331 calculates a basis vector for each of k coordinates indicating a point (each of N points) included in the point cloud information, and performs conversion in such a manner that the k basis vectors are orthogonal to each other to generate a (N×k) orthonormal basis matrix.

The orthogonalization layer unit 331 performs orthogonalization processing by, for example, the following method.

A point cloud P indicated in point cloud data (k-dimensional point cloud data) indicating N (N≥2) points N in k (k≥2) dimensions is expressed by an N×k matrix, for example, as expressed in Expression (1). In this case, each point in the point cloud P is expressed using k coordinate values such as P_{N1}, . . . , and P_{Nk} as expressed in Expression (1).

$$P = ( \begin{matrix}{p}_{11} & … & {p}_{1 k} \\ ⋮ & ⋱ & ⋮ \\ {p}_{N 1} & … & {p}_{Nk}\end{matrix} ) ∈ {ℝ}^{N \times k} \qquad ( 1 )$$

It is assumed that the center of gravity of the point cloud P is translated to the origin of coordinates.

The orthogonalization layer unit 331 calculates a basis vector for each of the k coordinates.

The orthogonalization layer unit 331 performs orthogonalization orth on the point cloud P as illustrated in Expression (2) in order to perform conversion in such a manner that the k basis vectors are orthogonal to each other.

The orthogonalization layer unit 331 obtains an orthonormal basis matrix X by the orthogonalization orth.

Specifically, as the orthogonalization orth, Gram-Schmidt orthogonalization method X=GramSchmit(P) may be used, a QR decomposition (X, r=QR(P)) may be used, a singular value decomposition (X, σ, V^{T}=SVD(P)) may be used, or an eigenvalue decomposition (X, Λ=EIG(P)) may be used.

$$orth ( P ) = X , s . t . {X}^{T} X = {I\_}_{k} \qquad ( 2 )$$

In Expression (2), “Ik” represents a k×k identity matrix.

The projection layer unit 332 calculates a projection matrix indicating the rotation invariant feature using the orthonormal basis matrix and the model.

The projection layer unit 332 extracts a projection matrix M, which is a k-dimensional rotation invariant feature (rotation invariant feature), from the orthonormal basis matrix obtained by the orthogonalization layer unit 331.

The projection matrix M is calculated using the following Expression (3).

$$M = {XX}^{T} \qquad ( 3 )$$

Here, when the projection matrix is calculated using a matrix XR obtained by causing k-dimensional rotation (rotation R) of the orthonormal basis matrix X, the following Expression (4) is established.

$${XR ( XR )}^{T} = {XX}^{T} = M \qquad ( 4 )$$

For this reason, the projection matrix M is invariable to the rotation R (rotation-invariable).

The projection layer unit 332 calculates and outputs a matrix “Y” obtained by multiplying the projection matrix M by a learning parameter W included in the model as in the following expression (5). In the present disclosure, the learning parameter W illustrated in Expression (5) is a parameter that indicates a geometrically meaningful first weight and finally becomes a constant by learning.

$$Y = M W \qquad ( 5 )$$

The projection matrix M is geometrically a projection matrix to a space spanned by the projection matrix M.

“Y” expressed in Expression (5) represents a point cloud (shape) in a case where “W” is projected to a space spanned by “M” by multiplying the projection matrix M by “W” from the right. Thus, “Y” is shape information geometrically independent of rotation, and indicates a rotation invariant feature.

Then, by using this, the projection layer unit 332 can obtain the same “Y” from the point cloud P before rotation (orthonormal basis matrix X) and a point cloud PR after rotation (orthonormal basis matrix XR), as described later with reference to FIGS. 6A and 6B.

On the other hand, the projection layer unit 332 can obtain different “Y” and “Y_hat” (this indicates that “Y” obtained by Expression (5) is different) from the point cloud P1 (orthonormal basis matrix X1) and the point cloud P2 (orthonormal basis matrix X2) having different shapes.

The rotation invariant converting unit 330 illustrated in FIG. 2 performs orthogonalization of each of basis vectors for each of points indicated in the point cloud information as described above, for example, and calculates the rotation invariant feature by using data after the orthogonalization and model (learning parameter W indicating the first weight).

In a case where the rotation invariant converting unit 330 is configured as described above, the inference unit 340 identifies the point cloud indicated in the point cloud information using the projection matrix and the model indicating the rotation invariant feature.

An example of an internal configuration of the inference unit 340 will be described.

The inference unit 340 extracts a point cloud feature on the basis of a result of orthogonally projecting a component indicated by the learning parameter to a subspace spanned by the orthonormal basis matrix in an N-dimensional space using the projection matrix and the model indicating the rotation invariant feature, and identifies the point cloud using the point cloud feature. Specifically, the class identification of the point cloud is performed.

The point cloud feature constructed by the inference unit 340 will be described with reference to FIGS. 5 and 6.

First, the rotation of the point cloud will be described.

In FIG. 5, a ∘ (white circle) point cloud 1100 represents a two-dimensional point cloud X before rotation, and • (black circle) point cloud 1200 represents a two-dimensional point cloud XR (π) after rotation.

The two-dimensional point cloud X in FIG. 5 is represented by a matrix X in which x₁₁ is −0.5, x₁₂ is −1.625, x₂₁ is 0.5, x₂₂ is −0.625, x₃₁ is −1.5, x₃₂ is 3.375, x₄₁ is 1.5, and x₄₂ is −1.125.

The two-dimensional point cloud XR (x) in FIG. 5 is represented by a matrix XR(π) in which xr₁₁ is 0.5, xr₁₂ is 1.625, xr₂₁ is −0.5, xr₂₂ is 0.625, xr₃₁ is 1.5, xr₃₂ is −3.375, xr₄₁ is −1.5, and xr₄₂ is 1.125.

As illustrated in FIG. 5, when the point cloud data is rotated, the position coordinates change, and thus the information before and after the rotation is different as numerical data.

Although the ∘ (white circle point) group and the • (black circle point) group are expressed by different coordinate values due to the rotation, since the object indicated by the point cloud is the same as the object even if the coordinates change before and after the rotation, even the rotated point cloud can be identified with the same accuracy (object of the same category) without changing the essential information.

In this regard, feature construction based on the projection matrix M by the inference unit 340 can be geometrically described with reference to FIG. 6.

The orthonormal basis matrix X is a matrix in which the k basis vectors of each of N points are arranged as in the following expression (6).

$$X = ( \begin{matrix}{x}_{11} & … & {x}_{1 k} \\ ⋮ & ⋱ & ⋮ \\ {x}_{N 1} & … & {x}_{Nk}\end{matrix} ) \qquad ( 6 )$$

The orthonormal basis matrix X spans a k-dimensional subspace spanX in an N-dimensional space. That is, the subspace spanX is a space generated by the orthonormal basis matrix X.

In FIG. 6A, a subspace 2100 (spanX) represents a column space of an orthonormal basis matrix X obtained from the point cloud P. The orthonormal basis matrix X in FIG. 6A indicates that x₁₁ is −0.5, x₁₂ is −1.625, x₂₁ is 0.5, x₂₂ is −0.625, x₃₁ is −1.5, x₃₂ is 3.375, x₄₁ is 1.5, and x₄₂ is −1.125.

In FIG. 6A, a subspace 2200 (spanXR) represents a column space of an orthonormal basis matrix XR obtained from the point cloud PR. The orthonormal basis matrix XR (x) in FIG. 6A indicates that xr₁₁ is 0.5, xr₁₂ is 1.625, xr₂₁ is −0.5, xr₂₂ is 0.625, xr₃₁ is 1.5, xr₃₂ is −3.375, xr₄₁ is −1.5, and xr₄₂ is 1.125.

The orthonormal basis matrix X and the orthonormal basis matrix XR are orthonormal basis matrices generated from point clouds having the same shape. In this case, the subspace 2100 (spanX) and the subspace 2200 (spanXR) coincide with each other.

In FIG. 6B, the subspace 3100 (spanX1) represents a column space of the orthonormal basis matrix X1 obtained from the point cloud P1. The orthonormal basis matrix X1 in FIG. 6B indicates that x1₁₁ is −0.5, x1₁₂ is −1.625, x1₂₁ is 0.5, x1₂₂ is −0.625, x1₃₁ is −1.5, x1₃₂ is 3.375, x1₄₁ is 1.5, and x1₄₂ is −1.125.

In FIG. 6B, the subspace 3200 (spanX2) represents a column space of the orthonormal basis matrix X2 obtained from the point cloud P2. The orthonormal basis matrix X2 in FIG. 6B indicates that x2₁₁ is −4.676, x2₁₂ is 3.1419615, x2₂₁ is 3.892, x2₂₂ is 5.1419615, x2₃₁ is 1.892, x2₃₂ is −7.4258845, x2₄₁ is −1.108, and x2₄₂ is −0.8580385.

The orthonormal basis matrix X1 and the orthonormal basis matrix X2 are orthonormal basis matrices generated from point clouds having different shapes. In this case, the subspace 3100 (spanX1) and the subspace 3200 (spanX2) do not match.

Using this fact, the inference unit 340 extracts a point cloud feature, which is a feature effective for identifying a point cloud, using an orthonormal basis matrix for each point cloud.

The inference unit 340 extracts a point cloud feature Z using, for example, the following Expression (7).

$$Z = Φ ( X ) = σ ( WY ) + B \qquad ( 7 )$$

In Expression (7), “Y” is obtained by multiplying the projection matrix M by the parameter W indicating the first weight as expressed in Expression (5).

In Expression (7), the learning parameter W indicates a weight (second weight), and a learning parameter B (second learning parameter) indicates a bias.

Expression (7) indicates that a feature extraction function Φ as a feature extractor has a learning parameter (a parameter W indicating a first weight, a parameter W indicating a second weight, and a parameter B indicating a bias) and a nonlinear conversion function σ for nonlinear conversion, and the point cloud feature Z is extracted by inputting the orthonormal basis matrix X to the feature extraction function Φ.

Extracting the point cloud feature Z by Φ(X) in Expression (7) corresponds to performing orthogonal projection onto the subspace spanX (subspace 2100) spanned by the orthonormal basis matrix X.

In the orthogonal projection to the subspace spanX (subspace 2100) and the subspace spanXR (subspace 2200), since these subspaces coincide with each other, the parameter W is projected to the same coordinates. This corresponds to extracting a rotation invariant feature unique to the point cloud shape.

On the other hand, orthogonal projections to the subspace spanX1 (subspace 3100) and the subspace spanX2 (subspace 3200) project the parameter W to different coordinates because these subspaces do not match.

In this manner, the point cloud information can be identified using the point cloud shape-specific features that do not depend on the coordinates of the point cloud.

Note that, in the description, the inference unit 340 is configured to receive “Y” calculated by multiplying the projection matrix (projection matrix M) by the learning parameter (parameter W indicating the first weight) included in the model and output by the projection layer unit 332, but the same applies when it is configured in the inference unit 340 to multiply the projection matrix (projection matrix M) by the learning parameter (parameter W indicating the first weight) included in the model. In the case of such a configuration, the projection layer unit 332 outputs the projection matrix M as it is.

The result output device 900 receives and outputs a classification result of the point cloud output from the point cloud identifying device 300. The result output device 900 only needs to be a device using the classification result of the point cloud, and may be, for example, a display device that simply displays the result or a control device related to automated driving of a vehicle.

The processing of the point cloud identifying device 300 will be described with reference to FIGS. 3 and 4.

Upon starting the processing, the point cloud identifying device 300 executes model acquiring processing (step ST110).

Specifically, the model acquiring unit 310 in the point cloud identifying device 300 acquires a model having a learning parameter from the storage unit 210 of the storage device 200. The model acquiring unit 310 outputs the model having the learning parameter.

The point cloud identifying device 300 executes point cloud acquiring processing (step ST120).

Specifically, the point cloud acquiring unit 320 in the point cloud identifying device 300 acquires point cloud information indicating N (N≥2) points in k (k≥2) dimensions from the point cloud input device 100. The point cloud acquiring unit 320 outputs the acquired point cloud information.

The point cloud identifying device 300 executes rotation invariant converting processing (step ST130).

Specifically, the rotation invariant converting unit 330 in the point cloud identifying device 300 performs orthogonalization of each of basis vectors for each of points indicated in the point cloud information, and calculates the rotation invariant feature by using data after the orthogonalization.

A specific example of the rotation invariant converting processing will be described.

Upon starting the rotation invariant converting processing, the rotation invariant converting unit 330 executes orthogonalization processing (step ST131) as illustrated in FIG. 4.

Specifically, the orthogonalization layer unit 331 in the rotation invariant converting unit 330 calculates a basis vector for each of k coordinates indicating a point (each of N points) included in the point cloud information, and performs conversion in such a manner that the k basis vectors are orthogonal to each other to generate a (N× k) orthonormal basis matrix.

The orthogonalization layer unit 331 uses, for example, the Gram-Schmidt orthogonalization method, the QR decomposition, the singular value decomposition, or the eigenvalue decomposition to perform conversion in such a manner that the basis vectors are orthogonal to each other to generate a (N× k) orthonormal basis matrix. The orthogonalization layer unit 331 outputs an orthonormal basis matrix.

The rotation invariant converting unit 330 executes projection processing (step ST132).

Specifically, the projection layer unit 332 in the rotation invariant converting unit 330 acquires the orthonormal basis matrix from the orthogonalization layer unit 331. The projection layer unit 332 calculates a projection matrix indicating the rotation invariant feature by using the orthonormal basis matrix. The projection layer unit 332 acquires the model from the model acquiring unit 310, multiplies the projection matrix (projection matrix M) by the learning parameter (learning parameter W indicating the first weight) included in the model, and outputs a result.

The point cloud identifying device 300 executes inference processing (step ST140).

Specifically, the inference unit 340 in the point cloud identifying device 300 first acquires the projection matrix from the projection layer unit 332, and acquires the model (the learning parameter W indicating a second weight and the learning parameter B indicating a bias) from the model acquiring unit 310. Next, the inference unit 340 uses the rotation invariant feature and the model to identify the point cloud indicated in the point cloud information. More specifically, as described above, the inference unit 340 extracts a point cloud feature on the basis of a result of orthogonally projecting a component indicated by the learning parameter to a subspace spanned by the orthonormal basis matrix in an N-dimensional space using the projection matrix and the model indicating the rotation invariant feature, and identifies the point cloud using the point cloud feature.

Note that, in a case where the projection layer unit 332 in the rotation invariant converting unit 330 is configured to output the projection matrix without multiplying the learning parameter (parameter W), the projection matrix is multiplied by the learning parameter (parameter W) in the inference unit 340.

The point cloud identifying device 300 executes result output processing (step ST150).

Specifically, the result output unit 350 in the point cloud identifying device 300 outputs a classification result by identification of the inference unit 340 to the result output device 900.

The point cloud identifying device 300 determines whether to end the series of processing (step ST160).

When determining not to end the processing (step ST160 “NO”), the point cloud identifying device 300 proceeds to processing of step ST110 and repeats the processing from step ST110.

When determining to end the processing (step ST160 “YES”), the point cloud identifying device 300 ends the processing.

An example of an effect of the point cloud identifying device of the present disclosure will be described.

For example, in automated driving technology, in order to grasp the surrounding environment of a vehicle, other vehicles and obstacles in the periphery are identified using the point cloud data. In this case, by processing the point cloud data in real time and identifying the point cloud, it is possible to check the presence of a preceding vehicle for avoiding a collision or to grasp an obstacle, rubble, or the like left ahead in the automated driving device. At this time, there is a case where the point cloud is rotated in order to recognize a state when the point cloud is viewed from various viewpoints, and conventionally, processing such as data expansion by rotation and posture adjustment is separately required.

On the other hand, in the present disclosure, as described above, the configuration in which the point cloud data is expressed by the orthonormal basis matrix, is treated as one subspace, and the projection matrix is treated as data to acquire rotation invariance has been described. In the present disclosure, since the point cloud is expressed as rotation invariant data, if only a single posture is learned, it is equivalent to being learned for every posture, and it is possible to acquire an identification model robust to every rotation, whereby not only learning can be made efficient, but also the same identification accuracy can be obtained before and after rotation.

The point cloud identifying device of the present disclosure is configured as follows.

A point cloud identifying device including:
a point cloud acquiring unit to acquire point cloud information indicating N (N≥2) points in k (k≥2) dimensions;
a model acquiring unit to acquire a model having a learning parameter;
a rotation invariant converting unit to perform orthogonalization of each of basis vectors for each of points indicated in the point cloud information, and calculate a rotation invariant feature by using data after the orthogonalization;
an inference unit to identify a point cloud indicated in the point cloud information by using the rotation invariant feature and the model; and
a result output unit to output a classification result by identification of the inference unit.

Thus, the present disclosure has an effect that a point cloud identifying device that improves accuracy of identifying a point cloud can be provided.

The point cloud identifying method of the present disclosure is configured as follows.

A point cloud identifying method including:
a point cloud acquiring step of causing a point cloud acquiring unit to acquire point cloud information indicating N (N≥2) points in k (k≥2) dimensions;
a model acquiring step of causing a model acquiring unit to acquire a model having a learning parameter;
a rotation invariant converting step of causing a rotation invariant converting unit to perform orthogonalization of each of basis vectors for each of points indicated in the point cloud information, and calculate a rotation invariant feature by using information after the orthogonalization;
an inference step of causing an inference unit to identify a point cloud indicated in the point cloud information by using the rotation invariant feature and the model; and
a result output step of causing a result output unit to output a classification result by identification of the inference unit.

Thus, the present disclosure has an effect that a point cloud identifying method that improves accuracy of identifying a point cloud can be provided.

The point cloud identifying device of the present disclosure is further configured as follows.

The point cloud identifying device, in which
the rotation invariant converting unit includes:
an orthogonalization layer unit to calculate a basis vector for each of k coordinates indicating a point included in the point cloud information, and perform conversion in such a manner that the k basis vectors are orthogonal to each other to generate an orthonormal basis matrix; and
a projection layer unit to calculate a projection matrix indicating the rotation invariant feature by using the orthonormal basis matrix, and
the inference unit
identifies a point cloud indicated in the point cloud information by using the projection matrix indicating the rotation invariant feature and the model.

Thus, the present disclosure has an effect that a point cloud identifying device capable of efficiently calculating a rotation invariant feature of a point cloud can be provided.

Furthermore, the present disclosure exhibits an effect similar to the above effect by applying the above configuration to the point cloud identifying method.

The point cloud identifying device of the present disclosure is further configured as follows.

In the point cloud identifying device, the inference unit
the inference unit,
by using the projection matrix indicating the rotation invariant feature and the model,
extracts a point cloud feature on a basis of a result of orthogonally projecting a component indicated by the learning parameter to a subspace spanned by the orthonormal basis matrix in an N-dimensional space, and identifies a point cloud using the point cloud feature.

Thus, the present disclosure has an effect that it is possible to provide a point cloud identifying device that identifies point cloud information using the point cloud shape-specific features that do not depend on the coordinates of the point cloud.

Furthermore, the present disclosure exhibits an effect similar to the above effect by applying the above configuration to the point cloud identifying method.

### Second Embodiment

A second embodiment describes a form of a learning device.

In the second embodiment, detailed description of the same contents as those already described will be omitted as appropriate.

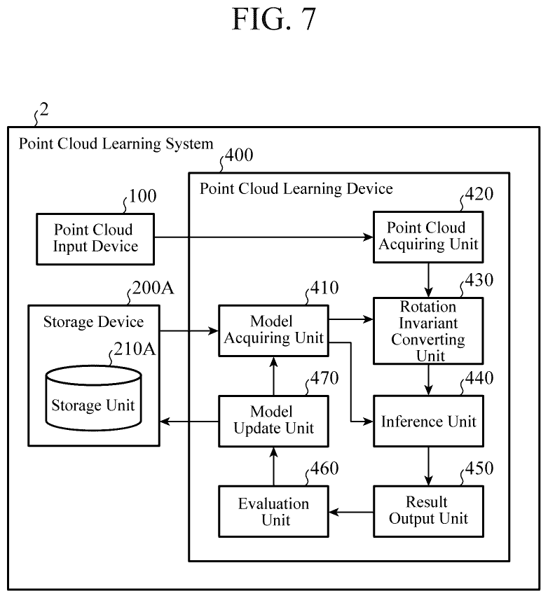

FIG. 7 is a diagram illustrating an example of a configuration of a point cloud learning system 2 including a point cloud learning device 400 according to the second embodiment.

The point cloud learning system 2 includes a point cloud input device 100, a storage device 200A, and a point cloud learning device 400.

The point cloud input device 100 is similar to the point cloud input device 100 described above, and thus a detailed description thereof will be omitted here.

The storage device 200A includes a storage unit 210A.

The storage unit 210A has information used for identification processing of identifying a point cloud. Specifically, the storage unit 210A has, for example, a learning parameter as a model for identification. The model is appropriately trained and updated by the point cloud learning device 400.

The point cloud learning device 400 trains a rotation invariant model in k-dimensional point cloud identification, and identifies a point cloud using the learned model.

The k-dimensional point cloud identification is to perform class identification of point cloud data indicating a point cloud represented in k dimensions on the basis of a feature such as a shape of the point cloud.

A configuration example of the point cloud learning device 400 will be described.

The point cloud learning device 400 includes a model acquiring unit 410, a point cloud acquiring unit 420, a rotation invariant converting unit 430, an inference unit 440, a result output unit 450, an evaluation unit 460, and a model update unit 470. The model acquiring unit 410 acquires a model having a learning parameter.

The learning parameter is a parameter trained by the point cloud learning device 400 and is a parameter used when the point cloud is identified.

The point cloud acquiring unit 420 acquires k-dimensional point cloud information of N points.

The point cloud acquiring unit 420 acquires point cloud information indicating N (N≥2) points in k (k≥2) dimensions, similarly to the point cloud acquiring unit 320 described above.

Similarly to the rotation invariant converting unit 330 described above, the rotation invariant converting unit 430 performs orthogonalization of each of basis vectors for each of points indicated in the point cloud information, and calculates a rotation invariant feature by using data after the orthogonalization.

Similarly to the inference unit 340 described above, the inference unit 440 uses the rotation invariant feature and the model to identify the point cloud indicated in the point cloud information. Specifically, the class identification of the point cloud is performed.

The result output unit 450 outputs a classification result by identification of the inference unit.

Specifically, the result output unit 450 outputs the classification result to the evaluation unit 460.

In addition, the result output unit 450 may be configured to further output the classification result to an external device. In this case, the external device may be, for example, the result output device 900 described in the first embodiment.

The evaluation unit 460 evaluates the model using the classification result.

As an evaluation method in the evaluation unit 460, various evaluation methods can be considered as long as the evaluation method is an index for measuring an error between an output label and a correct answer label. As a basic evaluation method, for example, there is an evaluation method using a cross entropy error function or a square error function.

The evaluation unit 460 outputs an evaluation result to the model update unit 470.

The model update unit 470 updates the model using the evaluation result by the evaluation unit 460.

Specifically, the model update unit 470 updates the learning parameter as the model stored in the storage unit 210A of the storage device 200A by rewriting the learning parameter.

For example, when using the evaluation result by the cross entropy error function, the model update unit 470 updates the parameter W in a direction in which the value of the error function is minimized. The direction in which the function value is minimized is a direction of a gradient in which the function decreases when the error function is differentiated by the parameter W of the model. Note that, at this time, the model update unit 470 may perform the update until the value of the error function converges, or may stop the update halfway when a predetermined condition is satisfied.

Further, the model update unit 470 performs update using a general optimization method such as a stochastic gradient descent method or a Newton method. Note that, at the time of gradient calculation, gradients of all parameters in the model are sequentially calculated using, for example, a method called back propagation.

An example of an internal configuration of the rotation invariant converting unit 430 will be described.

Here, the internal configuration of the rotation invariant converting unit 430 is obtained by replacing the orthogonalization layer unit 331 and the projection layer unit 332 in the rotation invariant converting unit 330 already described in FIG. 2 with an orthogonalization layer unit 431 and a projection layer unit 432, and is not illustrated.

The rotation invariant converting unit 430 includes an orthogonalization layer unit 431 and a projection layer unit 432.

Similarly to the orthogonalization layer unit 331 described above, the orthogonalization layer unit 431 calculates a basis vector for each of k coordinates indicating a point (each of N points) included in the point cloud information, and performs conversion in such a manner that the k basis vectors are orthogonal to each other to generate a (N× k) orthonormal basis matrix.

Similarly to the projection layer unit 332 described above, the projection layer unit 432 calculates a projection matrix indicating a rotation invariant feature using an orthonormal basis matrix.

The orthogonalization processing by the orthogonalization layer unit 431 is similar to the orthogonalization processing by the orthogonalization layer unit 331 described above, and a more detailed description thereof will be omitted here.

In a case where the rotation invariant converting unit 430 is configured in this manner, the inference unit 440 identifies the point cloud indicated in the point cloud information by using the projection matrix and the model indicating the rotation invariant feature.

An example of an internal configuration of the inference unit 440 will be described.

The inference unit 440 extracts a point cloud feature on the basis of a result of orthogonally projecting a component indicated by the learning parameter to a subspace spanned by the orthonormal basis matrix in an N-dimensional space using the projection matrix and the model indicating the rotation invariant feature, and identifies the point cloud using the point cloud feature. Specifically, the class identification of the point cloud is performed.

The point cloud feature constructed by the inference unit 440 is similar to the point cloud feature constructed by the inference unit 340 described above, and a more detailed description thereof will be omitted here.

Thus, the present disclosure can identify the point cloud information using the point cloud shape-specific features that do not depend on the coordinates of the point cloud.

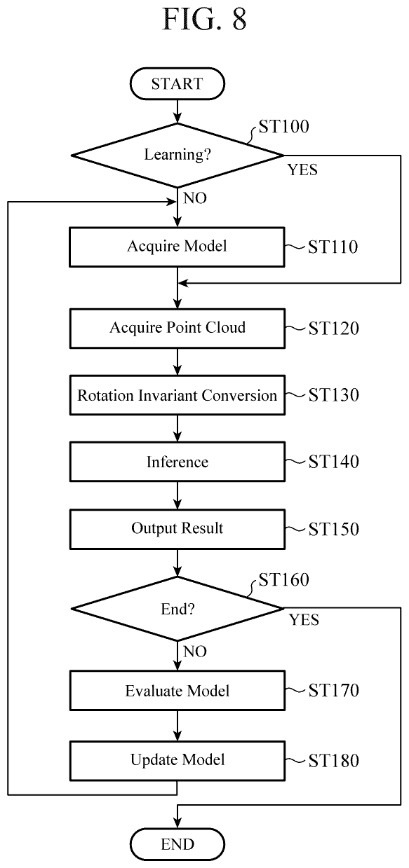

The processing of the point cloud identifying device will be described with reference to FIG. 8.

FIG. 8 is a flowchart illustrating an example of processing of the point cloud learning device 400.

Upon starting the processing, the point cloud learning device 400 first determines whether to perform learning (step ST100).

Specifically, the point cloud learning device 400 selects whether to learn the learning parameter from the beginning. The point cloud learning device 400 checks, for example, setting information set in advance, and determines whether to learn from the beginning or to use the learning parameter of the previously stored model.

When determining to perform learning (step ST100 “YES”), the point cloud learning device 400 proceeds to the processing of step ST120.

In a case of learning from the beginning, the point cloud learning device 400 may randomly initialize the learning parameter or may initialize the learning parameter using any initialization method that is generally used.

When the point cloud learning device 400 determines not to perform learning (step ST100 “NO”), the point cloud learning device 400 executes model acquiring processing (step ST110).

After determining to perform learning (step ST100 “YES”) or executing the model acquiring processing (step ST110), the point cloud learning device 400 executes the point cloud acquiring processing (step ST120).

Specifically, the point cloud acquiring unit 420 in the point cloud learning device 400 acquires point cloud information indicating N (N≥2) points in k (k≥2) dimensions from the point cloud input device 100. The point cloud acquiring unit 420 outputs the acquired point cloud information.

The point cloud learning device 400 executes rotation invariant converting processing (step ST130).

Specifically, the rotation invariant converting unit 430 in the point cloud learning device 400 performs orthogonalization of each of basis vectors for each of points indicated in the point cloud information, and calculates a rotation invariant feature by using data after the orthogonalization.

A specific example of the rotation invariant converting processing will be described. Note that the rotation invariant converting processing by the point cloud learning device 400 is similar to the rotation invariant converting processing of FIG. 4, and new illustration is omitted here.

Upon starting the rotation invariant converting processing, the rotation invariant converting unit 430 executes orthogonalization processing (step ST131) as illustrated in FIG. 4.

Specifically, the orthogonalization layer unit 431 in the rotation invariant converting unit 430 calculates a basis vector for each of k coordinates indicating a point (each of N points) included in the point cloud information, and performs conversion in such a manner that the k basis vectors are orthogonal to each other to generate a (N× k) orthonormal basis matrix. The orthogonalization layer unit 431 outputs an orthonormal basis matrix.

The rotation invariant converting unit 430 executes projection processing (step ST132).

Specifically, the projection layer unit 432 in the rotation invariant converting unit 430 acquires the orthonormal basis matrix from the orthogonalization layer unit 431. The projection layer unit 432 calculates a projection matrix indicating the rotation invariant feature by using the orthonormal basis matrix.

The point cloud learning device 400 executes inference processing (step ST140).

Specifically, the inference unit 440 in the point cloud learning device 400 first acquires the projection matrix from the projection layer unit 432 and acquires the model from the model acquiring unit 410. Next, the inference unit 440 uses the rotation invariant feature and the model to identify the point cloud indicated in the point cloud information.

More specifically, the inference unit 440 extracts a point cloud feature on the basis of a result of orthogonally projecting a component indicated by the learning parameter to a subspace spanned by the orthonormal basis matrix in an N-dimensional space using the projection matrix and the model indicating the rotation invariant feature, and identifies the point cloud using the point cloud feature.

The point cloud learning device 400 executes result output processing (step ST150).

Specifically, the result output unit 450 in the point cloud learning device 400 outputs the classification result by the identification of the inference unit 440 to the result output device 900.

The point cloud learning device 400 determines whether to end the series of processing (step ST160).

When determining to end the processing (step ST160 “YES”), the point cloud learning device 400 ends the processing.

When determining not to end the processing (step ST160 “NO”), the point cloud learning device 400 executes the model evaluation processing (step ST170).

Specifically, the evaluation unit 460 in the point cloud learning device 400 evaluates the model using the classification result. The evaluation unit 460 outputs an evaluation result to the model update unit 470.

The point cloud learning device 400 executes model update processing (step ST180).

The model update unit 470 updates the model using the evaluation result by the evaluation unit 460.

Specifically, the model update unit 470 updates the learning parameter as the model stored in the storage unit 210A of the storage device 200A by rewriting the learning parameter.

After executing the model update processing (step ST180), the point cloud learning device 400 proceeds to the processing of step ST110 and repeats the processing from step ST110.

The learning device (point cloud learning device) of the present disclosure is configured as follows.

A learning device including:
a point cloud acquiring unit to acquire point cloud information indicating N (N≥2) points in k (k≥2) dimensions;
a model acquiring unit to acquire a model having a learning parameter;
a rotation invariant converting unit to perform orthogonalization of each of basis vectors for each of points indicated in the point cloud information, and calculate a rotation invariant feature by using data after the orthogonalization;
an inference unit to identify a point cloud indicated in the point cloud information by using the rotation invariant feature and the model;
a result output unit to output a classification result by identification of the inference unit;
an evaluation unit to evaluate the model using the classification result; and
a model update unit to update the model using an evaluation result by the evaluation unit.

Thus, the present disclosure has an effect that a learning device that improves accuracy of identifying a point cloud can be provided.

The learning method (point cloud learning method) of the present disclosure is configured as follows.

A learning method including:
a point cloud acquiring step of causing a point cloud acquiring unit to acquire point cloud information indicating N (N≥2) points in k (k≥2) dimensions;
a model acquiring step of causing a model acquiring unit to acquire a model having a learning parameter;
a rotation invariant converting step of causing a rotation invariant converting unit to perform orthogonalization of each of basis vectors for each of points indicated in the point cloud information, and calculate a rotation invariant feature by using information after the orthogonalization;
an inference step of causing an inference unit to identify a point cloud indicated in the point cloud information by using the rotation invariant feature and the model;
a result output step of causing a result output unit to output a classification result by identification of the inference unit;
an evaluation step of causing an evaluation unit to evaluate the model using the classification result; and
a model update step of causing a model update unit to update the model using an evaluation result by the evaluation unit.

Thus, the present disclosure has an effect that a learning method that improves accuracy of identifying a point cloud can be provided.

The learning device (point cloud learning device) of the present disclosure is further configured as follows.

The learning device, in which
the rotation invariant converting unit includes:
an orthogonalization layer unit to calculate a basis vector for each of k coordinates indicating a point included in the point cloud information, and perform conversion in such a manner that the k basis vectors are orthogonal to each other to generate an orthonormal basis matrix; and
a projection layer unit to calculate a projection matrix indicating the rotation invariant feature by using the orthonormal basis matrix, and
the inference unit
identifies a point cloud indicated in the point cloud information by using the projection matrix indicating the rotation invariant feature and the model.

Thus, the present disclosure has an effect that a learning device capable of efficiently calculating a rotation invariant feature of a point cloud can be provided.

Furthermore, the present disclosure achieves an effect similar to the above effect by applying the above configuration to the above learning method.

The learning device (point cloud learning device) of the present disclosure is further configured as follows.

In the learning device, the inference unit includes:
the inference unit,
by using the projection matrix indicating the rotation invariant feature and the model,
extracts a point cloud feature on a basis of a result of orthogonally projecting a component indicated by the learning parameter to a subspace spanned by the orthonormal basis matrix in an N-dimensional space, and identifies a point cloud using the point cloud feature.

Thus, the present disclosure has an effect that it is possible to provide a learning device that identifies point cloud information using the point cloud shape-specific features that do not depend on the coordinates of the point cloud.

Furthermore, the present disclosure achieves an effect similar to the above effect by applying the above configuration to the above learning method.

Here, a hardware configuration that implements the functions of the point cloud identifying device 300 and the point cloud learning device 400 of the present disclosure will be described.

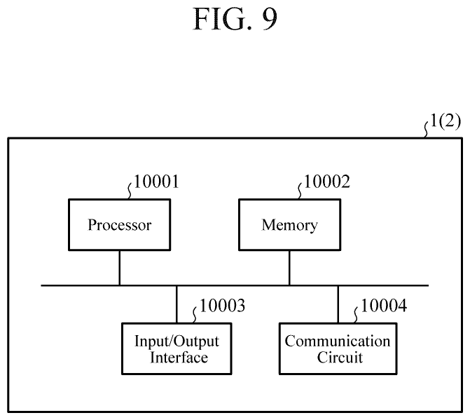

FIG. 9 is a diagram illustrating a first example of a hardware configuration for implementing the functions of the point cloud identifying device 300 and the point cloud learning device 400 in the present disclosure.

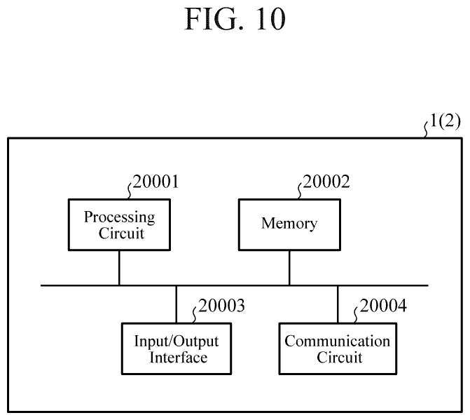

FIG. 10 is a diagram illustrating a second example of a hardware configuration for implementing the functions of the point cloud identifying device 300 and the point cloud learning device 400 in the present disclosure.

The point cloud identifying device 300 and the point cloud learning device 400 of the present disclosure are implemented by hardware as illustrated in FIG. 9 or 10.

As illustrated in FIG. 9, the point cloud identifying device 300 and the point cloud learning device 400 include, for example, a processor 10001, a memory 10002, an input/output interface 10003, and a communication circuit 10004.

The processor 10001 and the memory 10002 are mounted on a computer, for example.

The memory 10002 stores a program for causing the computer to function as a model acquiring unit 310, a point cloud acquiring unit 320, a rotation invariant converting unit 330, an inference unit 340, a result output unit 350, a model acquiring unit 410, a point cloud acquiring unit 420, a rotation invariant converting unit 430, an inference unit 440, a result output unit 450, an evaluation unit 460, a model update unit 470, and a control unit (not illustrated). When the processor 10001 reads and executes the program stored in the memory 10002, the functions of the model acquiring unit 310, the point cloud acquiring unit 320, the rotation invariant converting unit 330, the inference unit 340, the result output unit 350, the model acquiring unit 410, the point cloud acquiring unit 420, the rotation invariant converting unit 430, the inference unit 440, the result output unit 450, the evaluation unit 460, the model update unit 470, and the control unit that is not illustrated are implemented.

Further, a storage unit that is not illustrated is implemented by the memory 10002 or another memory that is not illustrated.

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD) or an optical magnetic disc.

The processor 10001 and the memory 10002 are connected in a state in which data can be transmitted to each other. Further, the processor 10001 and the memory 10002 are connected in a state in which data can be mutually transmitted with other hardware via the input/output interface 10003.

Furthermore, a communication unit (not illustrated) is implemented by the communication circuit 10004.

Alternatively, the functions of the model acquiring unit 310, the point cloud acquiring unit 320, the rotation invariant converting unit 330, the inference unit 340, the result output unit 350, the model acquiring unit 410, the point cloud acquiring unit 420, the rotation invariant converting unit 430, the inference unit 440, the result output unit 450, the evaluation unit 460, the model update unit 470, and the control unit that is not illustrated may be implemented by a dedicated processing circuit 20001 as illustrated in FIG. 10.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Further, a storage unit that is not illustrated is implemented by the memory 20002 or another memory that is not illustrated.

The memory 20002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD) or an optical magnetic disc.

The processing circuit 20001 and the memory 20002 are connected in a state in which data can be transmitted to each other. Further, the processing circuit 20001 and the memory 20002 are connected in a state in which data can be mutually transmitted with other hardware via the input/output interface 20003.

Furthermore, a communication unit (not illustrated) is implemented by the communication circuit 20004.

Note that the functions of the model acquiring unit 310, the point cloud acquiring unit 320, the rotation invariant converting unit 330, the inference unit 340, the result output unit 350, the model acquiring unit 410, the point cloud acquiring unit 420, the rotation invariant converting unit 430, the inference unit 440, the result output unit 450, the evaluation unit 460, the model update unit 470, and the control unit that is not illustrated may be implemented by different processing circuits, or may be collectively implemented by a processing circuit.

Alternatively, some of the functions of the model acquiring unit 310, the point cloud acquiring unit 320, the rotation invariant converting unit 330, the inference unit 340, the result output unit 350, the model acquiring unit 410, the point cloud acquiring unit 420, the rotation invariant converting unit 430, the inference unit 440, the result output unit 450, the evaluation unit 460, the model update unit 470, and the control unit that is not illustrated may be implemented by the processor 10001 and the memory 10002, and the remaining functions may be implemented by the processing circuit 20001.

Note that the present disclosure can freely combine the respective embodiments, modify any component of the respective embodiments, or omit any component of the respective embodiments within the scope of the invention. For example, the first embodiment and the second embodiment may be combined in such a manner that the result output unit outputs the point cloud identification result to the result output device and the model update unit via the evaluation unit. This makes it possible to achieve both the effects of the first embodiment and the effects of the second embodiment.

### INDUSTRIAL APPLICABILITY

Each of the point cloud identifying device and the learning device of the present disclosure can improve the accuracy of identifying the point cloud, and thus is suitable for use in identifying the point cloud in technologies such as vehicle control and driving assistance.

### REFERENCE SIGNS LIST

1: point cloud identifying system, 2: point cloud learning system, 100: point cloud input device, 200, 200A: storage device, 210, 210A: storage unit, 300: point cloud identifying device, 310: model acquiring unit, 320: point cloud acquiring unit, 330: rotation invariant converting unit, 331: orthogonalization layer unit, 332: projection layer unit, 340: inference unit, 350: result output unit, 400: point cloud learning device, 410: model acquiring unit, 420: point cloud acquiring unit, 430: rotation invariant converting unit, 431: orthogonalization layer unit, 432: projection layer unit, 440: inference unit, 450: result output unit, 460: evaluation unit, 470: model update unit, 900: result output device

1. A point cloud identifying device comprising:
processing circuitry configured to
acquire point cloud information indicating N (N≥2) points in k (k≥2) dimensions;
acquire a model having a learning parameter;
perform orthogonalization of each of basis vectors for each of points indicated in the point cloud information, and calculate a rotation invariant feature by using data after the orthogonalization;
identify a point cloud indicated in the point cloud information by using the rotation invariant feature and the model; and
output a classification result having been identified.

2. The point cloud identifying device according to claim 1, wherein
the processing circuitry is further configured to
calculate a basis vector for each of k coordinates indicating a point included in the point cloud information, and perform conversion in such a manner that the k basis vectors are orthogonal to each other to generate an orthonormal basis matrix; and
calculate a projection matrix indicating the rotation invariant feature by using the orthonormal basis matrix, and
identify the point cloud indicated in the point cloud information by using the projection matrix indicating the rotation invariant feature and the model.

3. The point cloud identifying device according to claim 2, wherein
the processing circuitry is further configured to
by using the projection matrix indicating the rotation invariant feature and the model,
extract a point cloud feature on a basis of a result of orthogonally projecting a component indicated by the learning parameter to a subspace spanned by the orthonormal basis matrix in an N-dimensional space, and identifies the point cloud using the point cloud feature.

4. A learning device comprising:
a processing circuitry configured to
acquire point cloud information indicating N (N≥2) points in k (k≥2) dimensions;
acquire a model having a learning parameter;
perform orthogonalization of each of basis vectors for each of points indicated in the point cloud information, and calculate a rotation invariant feature by using data after the orthogonalization;
identify a point cloud indicated in the point cloud information by using the rotation invariant feature and the model;
output a classification result having been identified;
evaluate the model using the classification result; and
update the model using an evaluation result.

5. The learning device according to claim 4, wherein
the processing circuitry is further configured to
calculate a basis vector for each of k coordinates indicating a point included in the point cloud information, and perform conversion in such a manner that the k basis vectors are orthogonal to each other to generate an orthonormal basis matrix; and
calculate a projection matrix indicating the rotation invariant feature by using the orthonormal basis matrix, and
identify the point cloud indicated in the point cloud information by using the projection matrix indicating the rotation invariant feature and the model.

6. The learning device according to claim 5, wherein
the processing circuitry is further configured to,
by using the projection matrix indicating the rotation invariant feature and the model,
extract a point cloud feature on a basis of a result of orthogonally projecting a component indicated by the learning parameter to a subspace spanned by the orthonormal basis matrix in an N-dimensional space, and identifies the point cloud using the point cloud feature.

7. A point cloud identifying method executed by a point cloud identifying device, comprising:
acquiring point cloud information indicating N (N≥2) points in k (k≥2) dimensions;
acquiring a model having a learning parameter;
performing orthogonalization of each of basis vectors for each of points indicated in the point cloud information, and calculating a rotation invariant feature by using information after the orthogonalization;
identifying a point cloud indicated in the point cloud information by using the rotation invariant feature and the model; and
outputting a classification result having been identified.

8. A learning method for a learning device, comprising:
acquiring point cloud information indicating N (N≥2) points in k (k≥2) dimensions;
acquiring a model having a learning parameter;
performing orthogonalization of each of basis vectors for each of points indicated in the point cloud information, and calculating a rotation invariant feature by using information after the orthogonalization;
identifying a point cloud indicated in the point cloud information by using the rotation invariant feature and the model;
outputting a classification result having been identified;
evaluating the model using the classification result; and
updating the model using an evaluation result.
